(19) United States
(12) Patent Application Publication
(10) Pub. No.: US 2009/0094188 A1
(43) Pub. Date: Apr. 9, 2009

(54) FACILITATING IDENTIFICATION OF AN OBJECT RECORDED IN DIGITAL CONTENT RECORDS

(76) Inventors: Edward Covannon, Ontario, NY (US); John R. Fyson, Hackney London (GB)

Correspondence Address: David A. Novais;Patent Legal Staff, Eastman Kodak Company, 343 State Steet, Rochester, NY, 14650-2201, US

(21) Appl. No.: 11/866,626

(22) Filed: Oct. 3, 2007

(51) Int. Cl. G06F 17/30

(52) U.S. Cl. 707/2; 707/E17.008

(57) ABSTRACT

Embodiments of the present invention facilitate identification of one or more objects in digital content records at least by knowing or estimating what region of space-time was captured by the digital content records and where the objects were located at various points in time. An object's location versus time is referred to herein as a space-time line. Any digital content record whose captured space-time region intersects with a particular object's space-time line is identified as having a possibility of having recorded the particular object.

### FIELD OF THE INVENTION

This invention relates to facilitating identification of objects recorded in digital content records. In particular, embodiments of the present invention pertain to facilitating identification of objects recorded in digital content records based at least upon knowing or estimating what regions of space-time were captured by the digital content records and where the objects were located at various points in time.

### BACKGROUND

The task of searching for specific digital content records, such as a digital still image, a digital audio file, a digital video file, etc., continues to become more challenging as ever larger numbers of digital content records are generated by ever larger numbers of capture devices. One common way users want to search their digital content records is by identifying objects, such as family members, within the digital content records. Conventional schemes for accomplishing these object-based searches include analyzing the actual recorded content of the digital content records or analyzing metadata associated with the digital content records. An example of the former is using face-recognition techniques to identify particular people in digital images. An example of the latter is knowing a particular person's name and then searching the metadata associated with digital content records for such person's name. While these techniques are useful and effective tools for identifying objects in digital content records, the complexity involved in this task presents an on-going need for improvement on the existing object-identification techniques or the development of new object-identification techniques.

### SUMMARY

The above-described problem is addressed and a technical solution is achieved in the art by systems and methods for identifying objects recorded in digital content records, according to various embodiments of the present invention. In an embodiment of the present invention a space-time line representing changes in an object's position in space over time is accessed. Also, a captured space-time region associated with each of a plurality of digital content records is accessed. Each captured space-time region represents a region of space captured by its associated digital content record at a particular time or span of time. Thereafter, digital content records are identified from the plurality of digital content records based at least upon identified intersections of the objects space-time line and the captured space-time regions. The identified digital content records or information pertaining thereto may be stored in a processor-accessible memory system.

Accordingly, by knowing where an object is located at various points in time, and knowing or estimating a region of space captured by each digital content record at a particular time or span of time, digital content records that may have captured the object can be readily identified. This technique is useful in its own right for identifying one or more objects in digital content records, or may be used in addition to conventional techniques for identifying objects in digital content records.

According to an embodiment of the present invention, an object's space-time line, at different points in time, may have different sizes. The different sizes may be proportional to an amount of precision as to known or expected whereabouts of the object. In cases where the object's space-time line has three space dimensions, the different sizes may be different volumes. In cases where the object's space-time line has only two space dimensions, the different sizes may be different areas.

In an embodiment of the present invention, an indication of a problematic representation of an object in a particular digital content record may be received. In this case, a source digital content record having similar characteristics as the particular digital content record and having a preferred representation of the object may be identified. Thereafter, the problematic representation of the object in the particular digital content record may be replaced with the preferred representation of the object from the source digital content record. In one example, the problematic representation of the object is a blurred representation of the object. In this case, the preferred representation of the object may be a less-blurred representation of the object as compared to the problematic representation of the object. The similar characteristics identified between the source digital content record and the particular digital content record may include a direction of capture, a location of capture, and a time-date of capture. In one example of this particular embodiment, the object may be a background of the particular digital content record.

In an embodiment of the present invention, a search may be performed for digital content records that may have captured multiple objects, such as a first object and a second object. In this embodiment, the step of identifying the digital content records may identify the digital content records from the plurality of digital content records based at least upon identified intersections of the captured space-time regions and (a) the first object's space-time line and (b) the second object's space-time line.

In an embodiment of the present invention, a space-time line for an object may be generated based at least upon first information indicating a first location of the object at a first particular time, and second information indicating a second location of the object at a second particular time different than the first particular time. Generated space-time lines may be stored in a processor-accessible memory system and made available to a data processing system to facilitate identification of an object in the digital content record.

Information indicating a location of the object at a particular time may be derived from an analysis of a digital content record that identifies a particular object. The object may be identified in a particular digital content record using image-processing space object-recognition techniques, or, for example, metadata associated with the particular digital content record. The first information or the second information also may be identified based upon user input.

If two points in space-time for the object are known or estimated, locations in space between the two particular times may be interpolated. Further, locations of the object in space after the latest of the particular times or before the earliest of the particular times, may be projected.

According to an embodiment of the present invention, a captured space-time region associated with a digital content record may be generated based at least upon the digital content record's location of capture, direction of capture, and time of capture. The generated space-time region may be stored in a processor-accessible memory system and made available to a data processing system to facilitate identification of an object in the digital content record.

The space-time region may be refined based at least upon second information indicating regions of space not captured by the digital content record at the particular time. For example, if conventional image processing techniques are used to analyze the digital content record and find a physical barrier located within the direction of capture, all regions within the captured space-time region behind the physical barrier can be eliminated from the captured space-time region.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 illustrates a system for facilitating identification of an object recorded in digital content records, according to an embodiment of the present invention;

FIG. 2 illustrates a method for facilitating identification of an object recorded in digital content records, according to an embodiment of the present invention;

FIG. 3 illustrates a method for generating a space-time line for an object, according to an embodiment of the present invention;

FIG. 4 illustrates a space-time line for an object, according to an embodiment of the present invention;

FIG. 5 illustrates a cross-section of a space-time line for an object, according to an embodiment of the present invention;

FIG. 6 illustrates a method for generating a captured space-time region for a digital content record, according to an embodiment of the present invention;

FIG. 7 illustrates a captured space-time region associated with a digital content record, according to an embodiment of the present invention;

FIG. 8 illustrates that captured space-time regions may be associated with an object, such as a capture device or user, according to an embodiment of the present invention;

FIG. 9 illustrates a conical captured space-time region generated by a digital camera, according to an embodiment of the present invention;

FIG. 10 illustrates different captured space-time regions generated by different capture settings for the same digital camera, according to an embodiment of the present invention;

FIG. 11 illustrates a captured space-time region for an omni-directional microphone, according to an embodiment of the present invention;

FIG. 12 illustrates an intersection of a captured space-time region and a space-time line of an object, according to an embodiment of the present invention;

FIGS. 13 and 14 illustrate replacing a background object in one digital content record with the same background object in another similar digital content record, according to an embodiment of the present invention;

FIG. 15 illustrates a method for facilitating identification of multiple objects recorded in digital content records, according to an embodiment of the present invention; and

FIG. 16 illustrates an intersection of a captured space-time region and two space-time lines from two different objects, according to an embodiment of the present invention.

It is to be understood that the attached drawings are for purposes of illustrating the concepts of the invention and may not be to scale.

### DETAILED DESCRIPTION

Embodiments of the present invention facilitate identification of one or more objects in digital content records at least by knowing or estimating what region of space-time was captured by the digital content records and where the objects were located at various points in time. For example, a captured space-time region may be generated for and associated with each digital content record in a collection of digital content records. The captured space-time regions may be generated based at least upon, for example, location of capture information, direction of capture information, and time of capture information from metadata associated with the digital content records. On the other hand, locations at various points of time for an object may be used to generate a space-time line associated with the object. The object's location at various points in time may be identified from any information that places the object within a region of space within a region of time. For example, in the case of the object being a person, information may be used from the person's cellular phone, a Global Positioning System (GPS) device, or even product-purchase receipts, such as a grocery store receipt, that place the individual within a region of space within a region of time.

Once a repository of captured space-time regions and object space-time lines has been generated, the repository may be queried to find a particular object that may have been recorded within the digital content records associated with the captured space-time regions. Any digital content record whose space-time region intersects with the particular object's space-time line is returned in response to the query.

It should be noted that the phrase, “digital content record”, as used herein, refers to any digital content record that captures a region of space-time, such as a digital still image, a digital audio file, a digital video file, etc. Further, it should be noted that, unless otherwise explicitly noted or required by context, the word “or” is used in this disclosure in a non-exclusive sense.

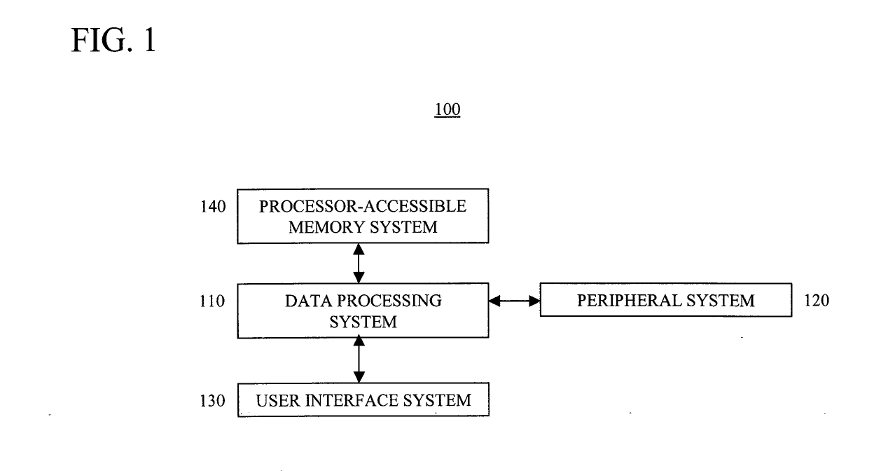

FIG. 1 illustrates a system 100 for facilitating identification of an object recorded in digital content records, according to an embodiment of the present invention. The system 100 includes a data processing system 110, a peripheral system 120, a user interface system 130, and a processor-accessible memory system 140. The processor-accessible memory system 140, the peripheral system 120, and the user interface system 130 are communicatively connected to the data processing system 110.

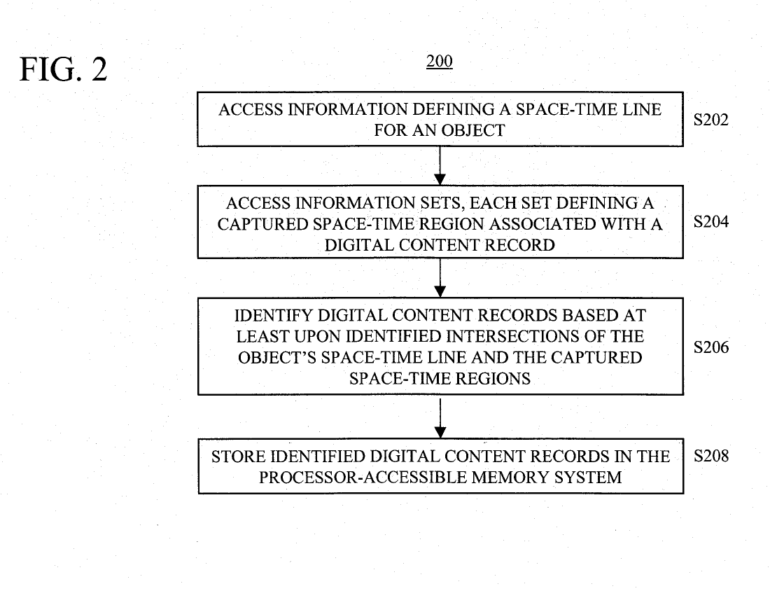

The data processing system 110 includes one or more data processing devices that implement the processes of the various embodiments of the present invention, including the example processes of FIGS. 2, 3, 6, and 15 described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The processor-accessible memory system 140 includes one or more processor-accessible memories configured to store information, including the information needed to execute the processes of the various embodiments of the present invention, including the example processes of FIGS. 2, 3, 6, and 15 described herein. The processor-accessible memory system 140 may be a distributed processor-accessible memory system including multiple processor-accessible memories communicatively connected to the data processing system 110 via a plurality of computers or devices. On the other hand, the processor-accessible memory system 140 need not be a distributed processor-accessible memory system and, consequently, may include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, floppy disks, hard disks, Compact Discs, DVDs, flash memories, ROMs, and RAMs.

The phrase “communicatively connected” is intended to include any type of connection, whether wired or wireless, between devices, data processors, or programs in which data may be communicated. Further, the phrase “communicatively connected” is intended to include a connection between devices or programs within a single data processor, a connection between devices or programs located in different data processors, and a connection between devices not located in data processors at all. In this regard, although the processor-accessible memory system 140 is shown separately from the data processing system 110, one skilled in the art will appreciate that the processor-accessible memory system 140 may be stored completely or partially within the data processing system 110. Further in this regard, although the peripheral system 120 and the user interface system 130 are shown separately from the data processing system 110, one skilled in the art will appreciate that one or both of such systems may be stored completely or partially within the data processing system 110.

The peripheral system 120 may include one or more devices configured to provide digital content records to the data processing system 110. For example, the peripheral system 120 may include digital video cameras, cellular phones, regular digital cameras, or other data processors. The data processing system 110, upon receipt of digital content records from a device in the peripheral system 120, may store such digital content records in the processor-accessible memory system 140.

The user interface system 130 may include a mouse, a keyboard, another computer, or any device or combination of devices from which data is input to the data processing system 110. In this regard, although the peripheral system 120 is shown separately from the user interface system 130, the peripheral system 120 may be included as part of the user interface system 130.

The user interface system 130 also may include a display device, a processor-accessible memory, or any device or combination of devices to which data is output by the data processing system 110. In this regard, if the user interface system 130 includes a processor-accessible memory, such memory may be part of the processor-accessible memory system 140 even though the user interface system 130 and the processor-accessible memory system 140 are shown separately in FIG. 1.

FIG. 2 illustrates a method 200 for facilitating identification of an object recorded in digital content records, according to an embodiment of the present invention. The method 200 may be performed, at least in part, by the data processing system 110. At step S202, information defining a space-time line for an object is accessed. The space-time line may be stored in the processor-accessible memory system 140 and represents locations of the object at various points in time. At step S204, information sets, each set defining at least a captured space-time region associated with a digital content record, are accessed. Each captured space-time region indicates a region of space captured by its corresponding digital content record at a particular time or span of time. With these information sets, step S206 involves identifying digital content records based at least upon identified intersections of the object's space-time line and the captured space-time regions. Results from step S206 may be stored in the processor-accessible memory system 140 at step S208.

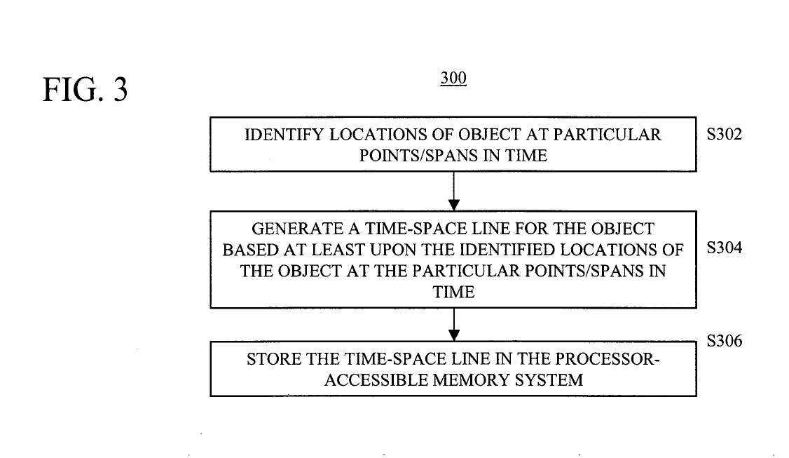

FIG. 3 illustrates a method for generating a space-time line for an object, according to an embodiment of the present invention. In this embodiment, at step S302 locations of the object at particular points in time are identified locations during any gaps between the points in time may be interpolated. Similarly, locations before the earliest known time and locations after the latest known time may be projected.

Locations of an object at particular points in time may be generated or acquired from any number of sources or techniques. For example, information from a GPS device attached to the object may be used (via the peripheral system 120 or the user interface system 130) to provide fairly precise locations of an object at many points in time. A cellular phone attached to the object may be used (via the peripheral system 120 or the user interface system 130) to provide information as to the object's whereabouts within a region of space. Documentary evidence may establish on object's location at a point in time. For example, a product-purchase receipt may indicate that the person buying the products identified on the receipt, as well as the products themselves (also objects), were at a particular store at a particular time. Accordingly, it can be seen that any information that can place an object within a region of space within a region of time can be used at step S302.

At step S304 a space-time line for the object is generated based at least upon the identified locations of the object at the particular points or spans of time. The generated space-time line will include the locations of the object at the particular points in time identified at step S302, as well as any interpolations between known time periods and, possibly projections beyond the earliest or latest known times. For example, if a person is known to have ended a day of work at a first particular time and to arrive home at a second particular time, the person's location at points of time between the particular times may be estimated based on an assumption that the person is driving home along the shortest route between the person's work location and the person's home.

At step S306, the space-time line generated at step S304 may be stored in the processor-accessible memory system 140 to facilitate later identification of the object in one or more digital content records.

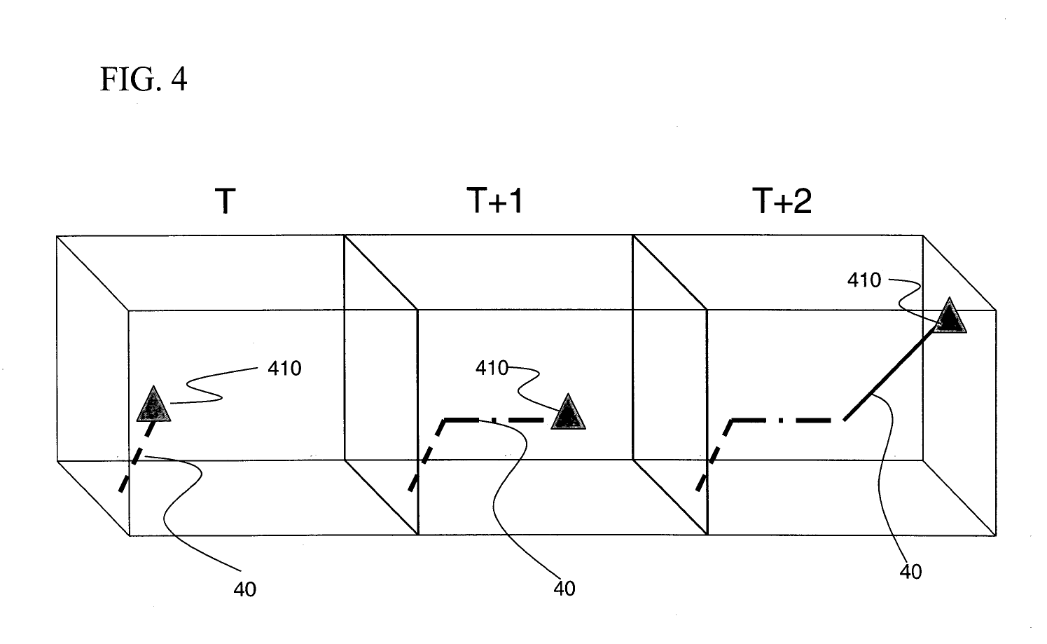

FIG. 4 illustrates a space-time line for an object, according to an embodiment of the present invention. Reference numeral 410 represents three known locations of an object, represented by a shaded triangle, at three different points in time T, T+1, and T+2. Lines 40 represent projections or interpolations of the object's location before or between the times T, T+1, and T+2. Although not shown in FIG. 4, a projection of the object's location beyond time T+2 may also exist. It should be noted that the line 40 at time T represents a projection of where the object was prior to time T, which is the earliest known location of the object. Lines 40 at times T+1 and T+2 represent interpolations of the objects location between times T and T+1 and between times T+1 and T+2, respectively.

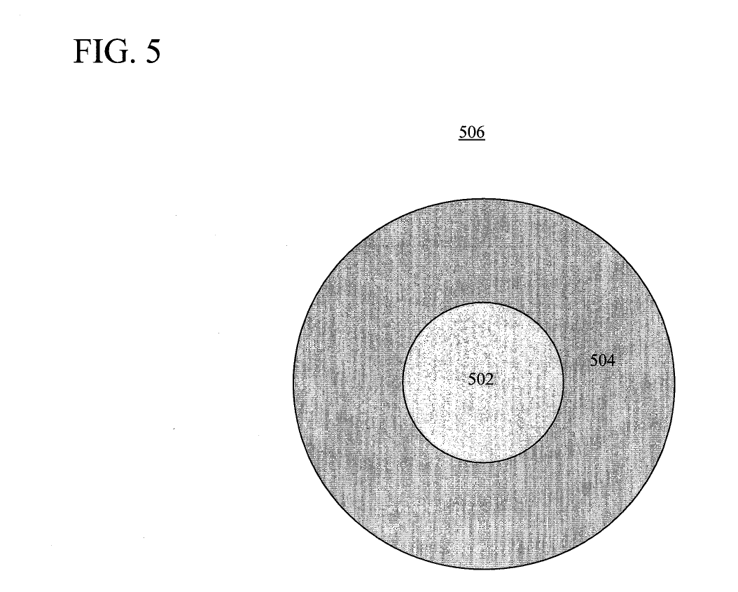

FIG. 5 illustrates a cross-section of a space-time line for an object, according to an embodiment of the present invention. FIG. 5 is a simplified representation of such a cross-section in that is assumes that only two-dimensions of space are accommodated in the space-time line and that the cross-section is taken at a particular point in time. However, one will appreciate that these “cross-sections” may be volumes instead of two-dimensional slices in the case where three-dimensions of space are accommodated in the space-time line.

With that said, the cross-section 506 in FIG. 5 is shown to have a circular shape with an inner circle 502 and an outer circle 504. In this example, the different shaded circles 502, 504 represent different probabilities of the object's location at the particular time represented in FIG. 5. For example, if the object is a person, and a product-purchase receipt indicates that the person bought a product at 12:00 P.M. on a particular date, and the cross-section in FIG. 5 is for 11:30 A.M. of the same date, the inner circle 502 may indicate the region of space occupied by the particular store where the product was purchased. This region of space may have a higher probability of the person being located therein because it is likely that the person was shopping in the store at 11:30 A.M., just prior to the person's check-out at 12:00 P.M. The outer circle 504 may indicate the region of space surrounding the store where the product was purchased. This region of space may have a lower probability that the object was located therein at 11:30 A.M., because, for example, it is less likely that the person was outside the store at 11:30 A.M. than it is that the person was inside the store. It is not impossible, however, because the person may have been traveling to the store at 11:30 A.M. or had to run out to their car at 11:30 A.M to get something.

It should be noted that although the cross-section 506 in FIG. 5 is circular in shape, one skilled in the art will appreciate that any shape or volume can exist for the cross section. For example, if it is known that the object was in a particular zip code within a span of time, cross sections of the space-time line within that span of time may have the shape of the zip code in which the object was located. Further in this regard, although the description herein uses the term “line” to describe a space-time line, one skilled in the art will appreciate that cross-sections of a “space-time line” described herein may not be of uniform shape and size. In other words, a single “space-time line” may have cross-sections having different shapes and sizes.

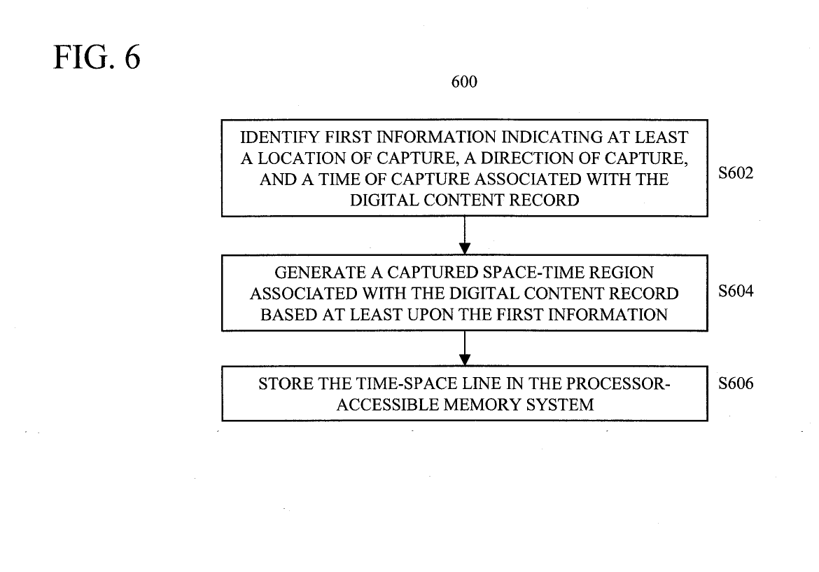

Having described the generation and characteristics of space-time lines, FIG. 6 illustrates a method 600 for generating a captured space-time region for a digital content record, according to an embodiment of the present invention. At a step S602, first information is identified indicating at least a location of capture, a direction of capture, and a time of capture associated with a digital content record. Such information may be input by a user via the user interface system 130 or may be derived by an analysis of metadata associated with the digital content record, as is known in the art.

At step S604 a captured space-time region associated with a digital content record is generated based at least upon the first information from step S602. The space-time region defines a region of space captured by the digital content record during the span of time that the digital content record was captured. At step S606, the generated space-time line may be stored in the processor-accessible memory system 140 to facilitate later identification of an object in the digital content record.

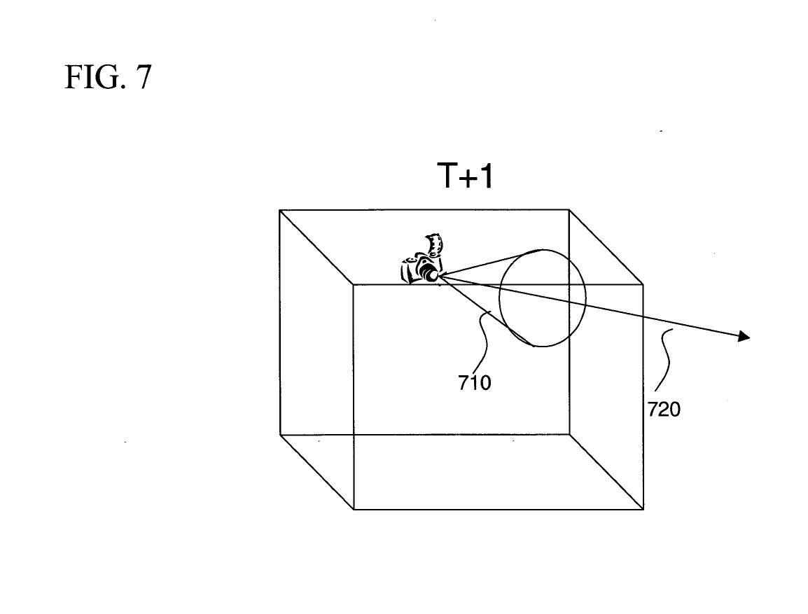

FIG. 7 illustrates a captured space-time region 710 associated with a digital content record, according to an embodiment of the present invention. In FIG. 7, the space-time region 710 was captured at a time T+1, has a conical shape, and a direction of capture 720.

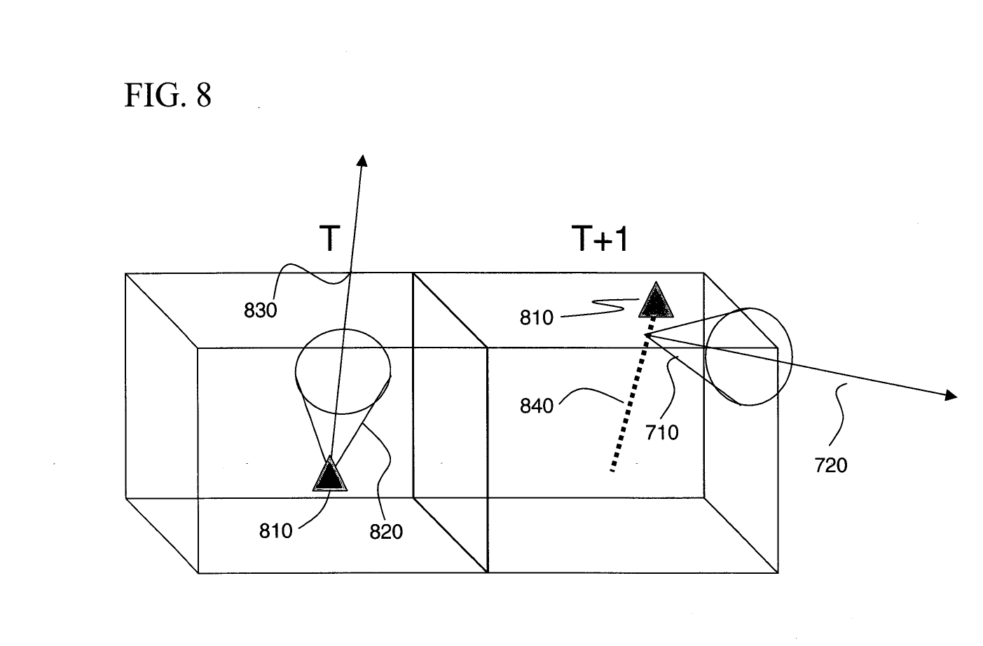

FIG. 8 illustrates an embodiment of the present invention where an object has associated therewith both a space-time line and one or more captured space-time regions. For example, in the case where the object 810 is a digital-content-record capture device, such as a digital camera, or is a user thereof, the object 810 may have associated therewith a space-time line 840 and captured space-time regions 820 and 710. Space-time line 840 would indicate the location of the object 810 at various points in time, such as time T, time T+1, and points in time therebetween. The captured space-time regions 820 and 710 each indicate a region of space recorded in a digital content record captured by the object at different times, such as time T and time T+1, respectively. Captured space-time region 820 has a direction-of-capture 830, and captured space-time region 710 has a direction-of-capture 720.

The embodiment of FIG. 8 may, for example, allow a user to replace the user's own poor quality digital content record with another one taken by someone else. For example, assume that a user of the system 100 in FIG. 1 took a picture of a historic building, but, unfortunately, the picture included an obstruction in front of the building that was not recognized by the user at the time of capture. In this case, the user may initiate a query process, such as that shown in FIG. 2, to find any objects that (a) are likely to be within the user's picture's captured space time region, and (b) have a captured space-time region associated therewith that includes the historic building.

For instance, the user's picture may have recorded another person who was also taking a picture of the historic building. Assume that other person is represented by the object 810, whose time-space line 840 intersected with the space-time region captured by the user's picture. Once the time-space line 840 of the object 810 in the user's picture is identified using the query process of FIG. 2, a follow-up query may be initiated to find any captured space-time regions associated with the space-time line 840 of the object 810 that include the historic building. In the example of FIG. 8, assume that the captured space-time region 710 includes the historic building. In this case, the user could retrieve the digital content record associated with the captured space-time region 710 to replace the user's own picture that included the obstructed view of the historic building.

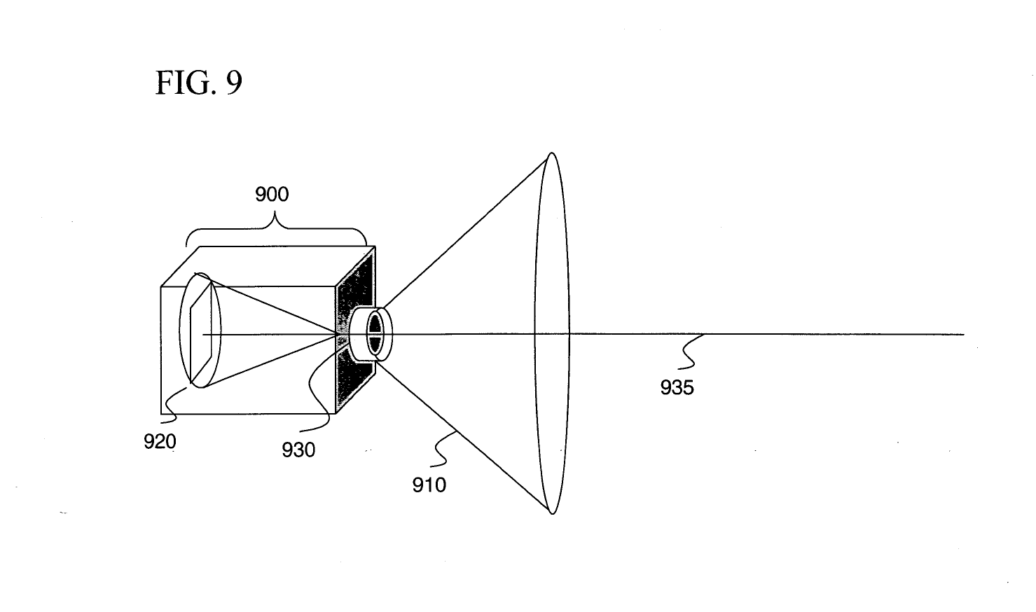

FIGS. 9-11 highlight that the present invention is not limited to any particular shape for a captured space-time region. In particular, FIG. 9 illustrates a conical captured space-time region generated by a digital camera, according to an embodiment of the present invention. As shown in FIG. 9, the digital camera 900 captures a conical segment of space-time 910 in a direction-of-capture 935. Light received via the lens 930 is recorded on a capture surface 920 having a rectangular shape. Because the capture surface 920 has a rectangular shape, it should be noted that the captured region of space-time 910 may be represented as an extending rectangle, as opposed to an extending circular region as shown in FIG. 9.

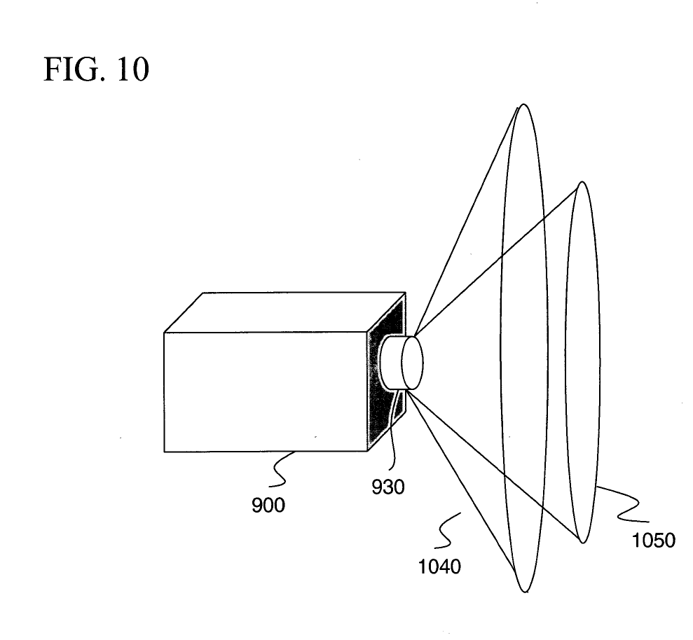

FIG. 10 illustrates different captured space-time regions generated by different capture settings for the same digital camera, according to an embodiment of the present invention. In the embodiment of FIG. 10, the digital camera 900 is capable of capturing different space-time regions, represented as 1040 and 1050, depending upon characteristics of the lens 930. For example, a wide field of view capture cone 1040 might be appropriate for a wide angle lens (a lens whose focal length is short) versus a narrow field of view cone 1050 for a lens whose focal length is long, where long and short are functions of the relationship to the diagonal of the capture surface 920, not shown in FIG. 10. Accordingly, FIG. 10 illustrates that the captured space-time region of a particular digital content record capture device can be dependent upon characteristics of the capture device unique to the particular capture.

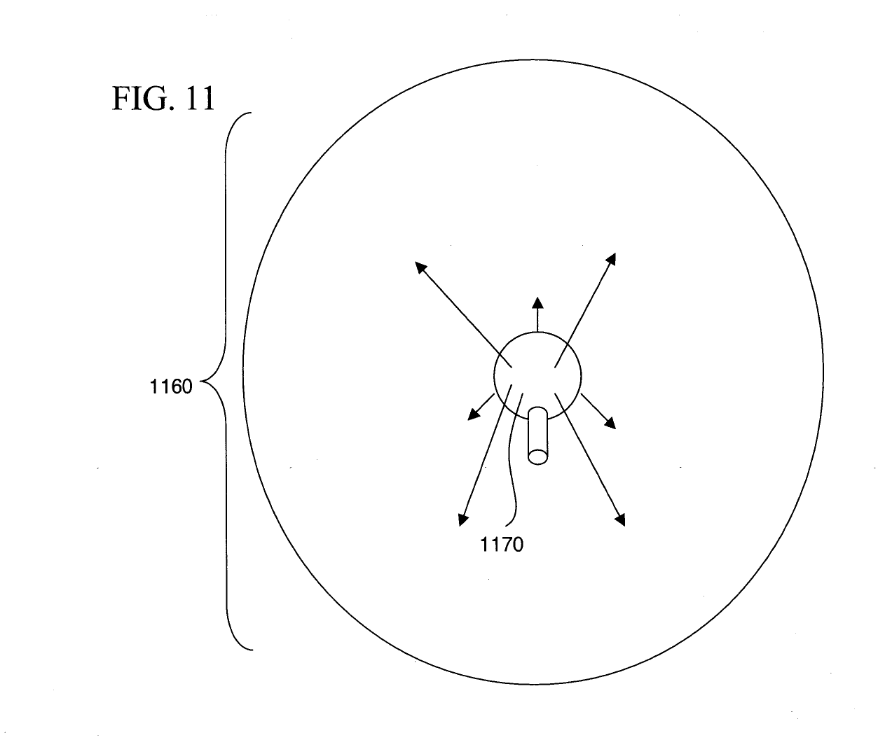

FIG. 11 illustrates a captured space-time region for an omni-directional microphone, according to an embodiment of the present invention. In particular, the omni-directional microphone 1170 captures audio in a spherical space-time region 1160.

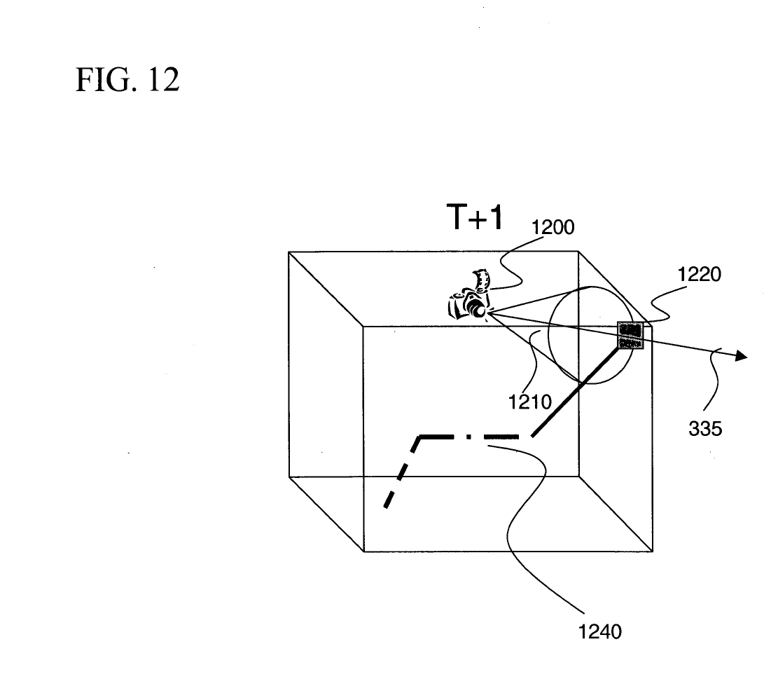

FIG. 12 illustrates an intersection of a captured space-time region and a space-time line of an object identified at step S206 in FIG. 2, according to an embodiment of the present invention. In particular, a capture device 1200 captures a region of space-time 1210. An object 1230 has a space-time line 1240 that intersects with the captured space-time region 1210. Consequently, it may be determined that the digital content record associated with the captured space-time region 1210 has a likelihood that it includes a representation of the object 1230 therein. Accordingly, at step S206 in FIG. 2, such digital content record would be identified. The intersection of the captured space-time region 1210 and the space-time line 1240 of the object 1230 may be determined using conventional mathematical techniques.

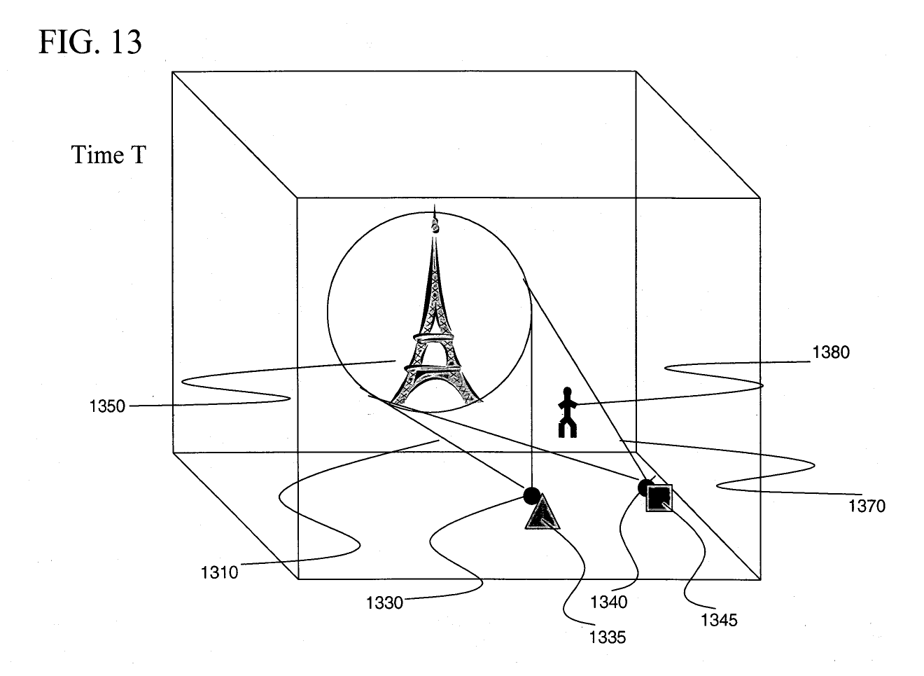

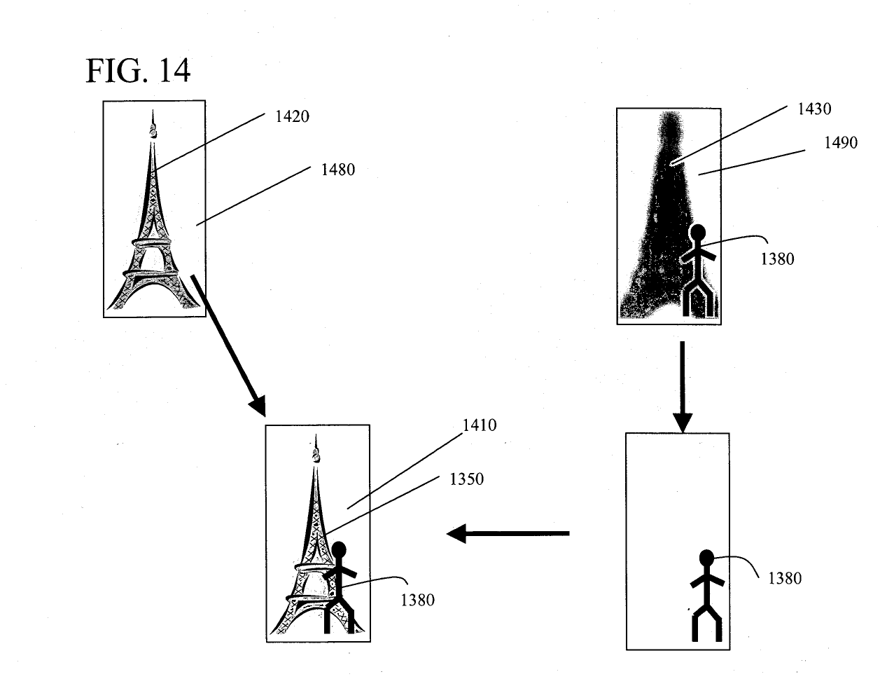

FIGS. 13 and 14 illustrate replacing a background object in one digital content record with the same background object in another similar digital content record, according to an embodiment of the present invention. Although FIGS. 13 and 14 pertain to background objects, one skilled in the art will appreciate that any type of object may be replaced according to the description below. In particular, assume at step S206 in FIG. 2 a group of digital content records are identified as having a space-time region that intersects an object, in this case the Eiffel Tower. Also assume that a user 1345 who captured the digital content record 1490 (FIG. 14) associated with the captured space-time region 1370 indicates that its representation of the object 1350 is problematic or undesirable. As shown in FIG. 14, the problematic representation may be a blurred representation of the object 1350. Accordingly, the data processing system 110 in FIG. 1 may search for a digital content record from those retrieved at step S206 that is most similar to the digital content record associated with space-time region 1370 and has a preferred representation of the object 1350. In this case, assume that the digital content record 1480 (FIG. 14) associated with the captured space-time region 1310 is the most similar and includes the preferred representation of the object 1350. Such similarity, or similar characteristics between the digital content records 1480 and 1490 may be or may include a direction of capture, a location of capture, and a time-date of capture. As shown in FIG. 14, once a similar digital content record 1480 is identified, the preferred representation of the object 1420 from the source digital content record 1480 may be used to replace the problematic representation of the object 1430 and the digital content record 1490. Such replacement may be used using image processing techniques known in the art. The replaced object is shown in the modified digital content record 1410 in FIG. 14.

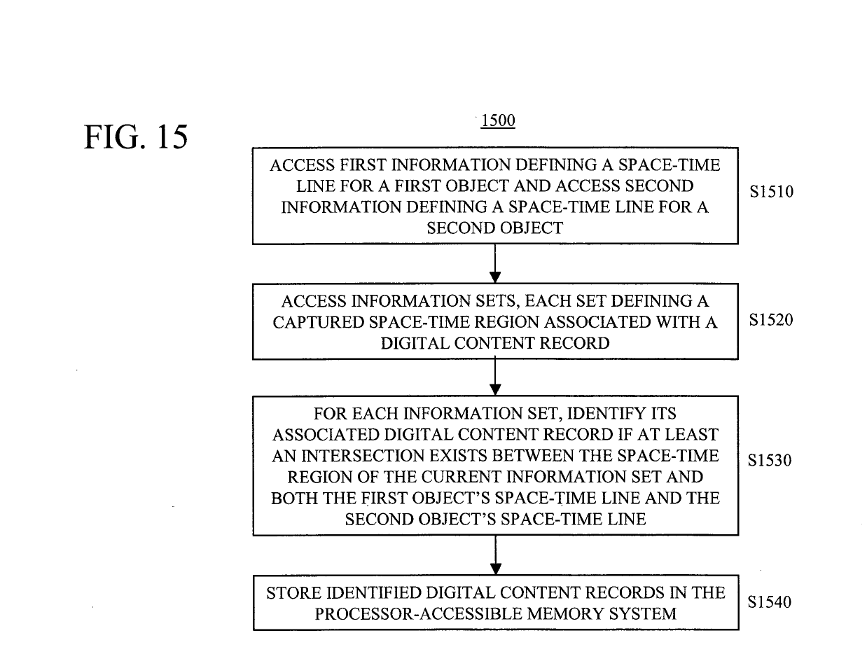

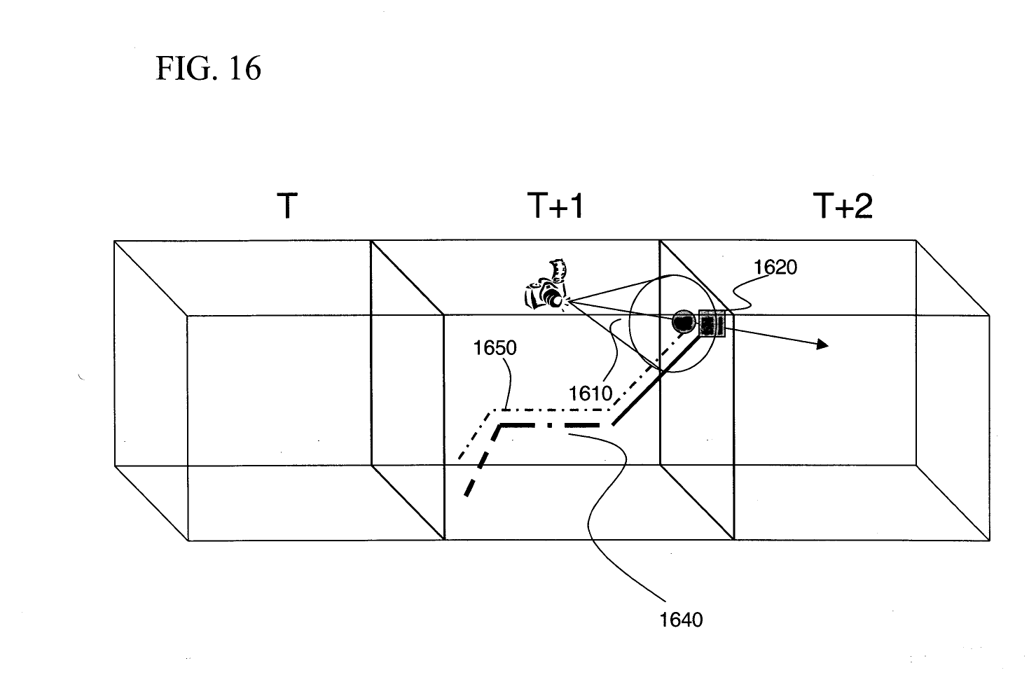

FIG. 15 illustrates a method for facilitating identification of multiple objects recorded in digital content records, according to an embodiment of the present invention. According to this embodiment, first information defining a space-time line for a first object and second information defining a space-time line for a second object is accessed at a step S1510. At step S1520, information sets, each defining at least the captured space-time regions associated with a digital content record, are accessed. At step S1530, a digital content record is identified as having a likelihood of having recorded both objects if at least an intersection exists between its captured space-time region and both the first object's space-time line and the second object's space-time line. Such a situation is illustrated in FIG. 16, where a captured space-time region 1610 intersects both the space-time line 1650 of an object 1630 and a space-time line 1640 of a second object 1620. At step S1540, the identified digital content records may be stored in the processor-accessible memory system 140.

It is to be understood that the example embodiments described above are merely illustrative of the present invention and that many variations of the above-described embodiments can be devised by one skilled in the art without departing from the scope of the invention. It is therefore intended that all such variations be included within the scope of the following claims and their equivalents.

### PARTS LIST

40 Line
100 System
110 Data processing system
120 Peripheral system
130 User interface system
140 Processor-accessible memory system
410 Reference numeral
502 Inner circle
504 Outer circle
506 Cross-section
710 Space-time region
720 Direction of capture
810 Location
820 Space-time region
830 Direction of capture
840 Space-time line
900 Digital camera
910 Conical segment of space-time
920 Capture surface
930 Lens
935 Direction of capture
1010 Data processing system
1040 Wide field of view capture cone
1050 Narrow field of view cone
1160 Spherical space-time region
1170 Omni-directional microphone
1200 Digital capture device
1210 Region of space-time
1230 Object
1240 Space-time align
1310 Space-time region
1330 Captured space-time region
1340 Captured space-time region
1345 User
1350 Object
1380 Subject object
1410 Modified digital content record
1420 Object
1430 Object
1480 Digital content record
1490 Digital content record
1610 Captured space-time region
1620 Object
1630 Object
1640 Space-time line
1650 Space-time line
S202 Step
S204 Step
S206 Step
S208 Step
S302 Step
S304 Step
S306 Step
S602 Step
S604 Step
S606 Step
S1510 Step
S1520 Step
S1530 Step
S1540 Step
T Point in time
T+1 Point in time
T+2 Point in time

1. A method implemented at least in part by a data processing system, the method for identifying digital content records from a plurality of digital content records and comprising the steps of:
accessing information defining a space-time line for an object, the space-time line representing changes in the object's position in space over time;
accessing information sets, each set defining a captured space-time region associated with one of the plurality of digital content records, each captured space-time region representing a region of space captured by its associated digital content record at a particular time;
identifying digital content records from the plurality based at least upon identified intersections of the object's space-time line and the captured space-time regions; and
storing results of the identifying step in a processor-accessible memory system.

2. The method of claim 1, wherein the object's space-time line, at different points in time, has different sizes.

3. The method of claim 2, wherein each of the different sizes is proportional to an amount of precision as to known or expected whereabouts of the object.

4. The method of claim 2, wherein the object's space-time line has three space dimensions, and the different sizes are different volumes.

5. The method of claim 2, wherein the object's space-time line has only two space dimensions, and the different sizes are different areas.

6. The method of claim 1, wherein the identified digital content records are selected digital content records, and wherein the method further comprises the steps of:
receiving an indication of a problematic representation of the object in a particular digital content record;
identifying, from the selected digital content records, a source digital content record having (a) similar characteristics as the particular digital content record, and (b) a preferred representation of the object; and
replacing the problematic representation of the object in the particular digital content record with the preferred representation of the object from the source digital content record.

7. The method of claim 6, wherein the problematic representation of the object is a blurred representation of the object.

8. (canceled)

9. The method of claim 6, wherein the similar characteristics include direction of capture, location of capture, and time-date of capture.

10. The method of claim 6, wherein the object is a background of the particular digital content record.

11. (canceled)

12. (canceled)

13. The method of claim 1, wherein the object is a person or a capture device.

14. (canceled)

15. (canceled)

16. (canceled)

17. A method implemented at least in part by a data processing system, the method for facilitating identification of an object in digital content records and comprising the steps of:
identifying first information indicating a first location of the object at a first particular time;
identifying second information indicating a second location of the object at a second particular time different than the first particular time;
generating a space-time line for the object based at least upon the first information and the second information, the space-time line representing changes in the object's position in space over time;
storing the space-time line in a processor-accessible memory system; and
making the space-time line available to a data processing system to facilitate identification of the object in digital content records.

18. The method of claim 17, wherein the step of identifying the first information comprises identifying the object in a particular digital content record captured at the first location at the first particular time.

19. The method of claim 18, wherein the object is identified in the particular digital content record based at least upon an image-processing object-recognition technique.

20. The method of claim 18, wherein the object is identified in the particular digital content record based at least upon metadata that identifies the object, the metadata associated with the particular digital content record.

21. (canceled)

22. The method of claim 17, wherein the step of generating the space-time line includes interpolating points in space-time between the first particular time and the second particular time.

23. The method of claim 17, wherein the step of generating the space-time line includes projecting points in space-time before or beyond all known points of time associated with the object's location.

24. The method of claim 17, wherein the space-time line, at different points in time, is generated to have different sizes.

25. The method of claim 24, wherein each of the different sizes is proportional to an amount of precision as to known or expected whereabouts of the object.

26. The method of claim 24, wherein the space-time line is generated to have three space dimensions, and the different sizes are different volumes.

27. The method of claim 24, wherein the object's space-time line has only two space dimensions, and the different sizes are different areas.

28. (canceled)

29. (canceled)

30. A method implemented at least in part by a data processing system, the method for facilitating identification of an object in a digital content record and comprising the steps of:
identifying first information indicating a location of capture, a direction of capture, and a time of capture associated with the digital content record;
generating a captured space-time region associated with the digital content record based at least upon the first information, the captured space-time region representing a region of space captured by the digital content record at a particular time;
storing the captured space-time region in a processor-accessible memory system; and
making the captured space-time region available to a data processing system to facilitate identification of an object in the digital content record.

31. The method of claim 30, further comprising the step of:
identifying second information indicating regions of space not captured by the digital content record at the particular time,
wherein the generating step generates the captured space-time region based at least upon the first information and the second information.

32. The method of claim 31, wherein, in the generating step, the second information is used to reduce a size of the captured space-time region initially identified using the first information alone.

33. The method of claim 31, wherein the second information indicates at least characteristics of a physical barrier located within the direction of capture.

34. (canceled)

35. The method of claim 31, wherein the generating step includes:
identifying a captured-space-time super-region based at least upon the first information;
identifying a blocked-space-time region based at least upon the second information, the blocked-space-time region representing a region of space at the particular time that was obstructed from a capture device that generated the digital content record;
removing the blocked-space-time region from the captured-space-time super region to produce a reduced-captured-space-time region; and
generating the captured space-time region based at least upon the reduced-captured-space-time region.

36. (canceled)

37. (canceled)
